(19) United States
(12) Patent Application Publication
(10) Pub. No.: US 2010/0289699 A1
(43) Pub. Date: Nov. 18, 2010

(54) Method and Apparatus for Determining a Position of a Mobile Station in a Wireless Communication System

(76) Inventors: Cheng-Hsuan Wu, Taipei City (TW); Chin-Tseng Huang, Hsinchu City (TW); Yung-Szu Tu, Taipei County (TW); Jiunn-Tsair Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/614,450

(22) Filed: Nov. 9, 2009

(30) Foreign Application Priority Data
May 18, 2009 (TW) 098116379

(51) Int. Cl. G01S 3/02

(52) U.S. Cl. 342/450

(57) ABSTRACT

A method for determining a position of a mobile station in a wireless communication system includes generating a state equation set according to a current state of the mobile station, for predicting a position and a velocity of the mobile station after a predetermined period, and corresponding the state equation set to a graphic interface for calculating the position and the velocity after the predetermined period.

### BACKGROUND OF THE INVENTION

1. Field of the Invention

The present invention is related to a method and apparatus for determining a position of a mobile station in a wireless communication system, and more particularly, to a method and apparatus achieving operations of position estimation and tracking by graphic interfaces, so as to simplify the operations of position estimation and tracking.

2. Description of the Prior Art

In wireless communication systems, such as a global positioning system (GPS), wireless network system, mobile communication system, etc., “position estimation and tracking” is an important technique and widely used in engineering and livelihood applications, such as personal position. Common position techniques include Time of Arrival (TOA), Time Difference of Arrival (TDOA), Angle of Arrival (AOA), Received Signal Strength (RSS), and their combinations. In general, TOA-based technique has the best precision, and utilizes the principal that a product of propagation time and propagation velocity (velocity of light, in general) of signals outputted by a base station is equal a distance between a mobile station and the base station. Therefore, at least three base stations are required for performing the TOA-based position technique.

To perform position estimation and tracking based on TOA, pre-built modules, for estimating transmission loses due to negative environment factors, such as a multipath effect, a shielding effect, etc., are required to determine the distance between the mobile station and the base stations based on TOA and thereby, to predict the movement of the mobile station. In such a situation, as the negative environment factors increase, the TOA-based algorithm becomes much more complicated. For that reason, various improved position estimation approaches have been disclosed in the prior art, such as “Kalman filtering”, which employs recursive estimation. That is, once an estimated value of a previous state and an observed value of the current state are given, an estimated value of the current state can be calculated without recording a history of the estimated and observed values. A representative embodiment is predicting a position and velocity of an object by a finite, noise-included, observed sequence of the object. In addition, with the advancement of technology, more complicated smoothing and filtering methods have been disclosed, such as a Kalman-based interacting multiple model smoother with LOS (line of sight) Mode and NLOS (non-line of sight) Mode, a self-adaptive extended Kalman filter, etc. However, these methods require massive and complex computation, and therefore are troublesome in practice.

For example, please refer to FIG. 1, which is a schematic diagram of a system model of the prior art according to the TOA-based position estimation and tracking. If a mobile station moves from a position A to a position B, and the system includes N base stations BS₁-BS_{N} (partially illustrated for simplicity), a distance \hat{d}_{i,k} between the mobile station and an arbitrary base station BSᵢ at the k-th sampling time point (within the time interval when the mobile station moves from the position A to the position B) can be expressed as:

\hat{d}_{i,k}=\sqrt{(\hat{x}ₖ−Xᵢ)²+(ŷₖ−Yᵢ)²},i=1,2, . . . , N (Eq. 1)

where (\hat{x}ₖ,ŷₖ) denotes an estimated coordinate vector of the mobile station, and (Xᵢ,Yᵢ) denotes an estimated coordinate vector of the base station BSᵢ. Taking noises and NLOS errors into consideration, the distance \hat{d}_{i,k} can be written as:

\hat{d}_{i,k}=d_{i,k}+e_{i,k}+e_{NLOS,i,k},i=1,2, . . . , N (Eq. 2)

where d_{i,k} denotes a real distance between the mobile station and the base station BSᵢ, e_{i,k} denotes a white noise which is an independent and identically distributed Gaussian random variable with zero mean and variance σ_{d}_{_{i,k}}², and e_{NLOS,i,k} denotes an NLOS error which is an independent and identically distributed Gaussian random variable with mean m_{NLOS} and variance σ_{NLOS}². The accuracy of the distance \hat{d}_{i,k} is merely affected by the white noise e_{i,k} in LOS mode but further affected by the NLOS error e_{NLOS,i,k} in NLOS mode.

The position of the mobile station can be solved based on Eq. 1 and Eq. 2. Next, to track the movement of the mobile station by Kalman filtering, a state equation set has to be established:

$$[ \begin{matrix}{x}_{k + 1} \\ {y}_{k + 1} \\ {v}_{x , k + 1} \\ {v}_{y , k + 1}\end{matrix} ] = [ \begin{matrix}1 & 0 & Δ t & 0 \\ 0 & 1 & 0 & Δ t \\ 0 & 0 & 1 & 0 \\ 0 & 0 & 0 & 1\end{matrix} ] \cdot [ \begin{matrix}{x}_{k} \\ {y}_{k} \\ {v}_{x {,}_{k}} \\ {v}_{y {,}_{k}}\end{matrix} ] + Δ t [ \begin{matrix}0 \\ 0 \\ {η}_{v , x , k} \\ {η}_{v , y , k}\end{matrix} ] \qquad ( Eq . 3 )$$

where xₖ and yₖ denote the position of the mobile station at the sampling time k (implying that xₖ₊₁ and yₖ₊₁ denote the predicted position of the mobile station at the next sampling time k+1), v_{x,k} and v_{y,k} respectively denote velocities along x and y directions, [0 0 η_{v,x,k} η_{v,y,k}]^{T} represents a Gaussian noise vector with a covariance matrix Q, and Δt denotes a duration of the sampling process. Thus, at the sampling time k, the observed position (z_{x,k},z_{y,k}) of the mobile station can be express as:

$$[ \begin{matrix}{z}_{x , k} \\ {z}_{y , k}\end{matrix} ] = [ \begin{matrix}1 & 0 & 0 & 0 \\ 0 & 1 & 0 & 0\end{matrix} ] \cdot [ \begin{matrix}{x}_{k} \\ {y}_{k} \\ {v}_{x {,}_{k}} \\ {v}_{y {,}_{k}}\end{matrix} ] + [ \begin{matrix}{w}_{x , k} \\ {w}_{y , k}\end{matrix} ] \qquad ( Eq . 4 )$$

where [w_{x,k} w_{y,k}]^{T} represents a Gaussian noise vector with a covariance matrix R.

Therefore, the current position of the mobile station can be estimated based on Eq. 1 and Eq. 2, and the position and velocity of the mobile station at the next sampling time point can be predicted based on Eq. 3 and Eq. 4. In such a way, as long as Eq. 1-Eq. 4 are solved at each sampling time, the estimated position of the mobile station can be repeatedly updated, and the movement of the mobile station can be accordingly predicted. However, such a process requires massive and complex matrix computation, especially when taking more factors into consideration, and therefore is disadvantageous in implementation.

### SUMMARY OF THE INVENTION

It is therefore a primary objective of the claimed invention to provide a method and apparatus for determining a position of a mobile station in a wireless communication system.

The present invention discloses a method for determining a position of a mobile station in a wireless communication system. The method comprises generating a state equation set according to a current state of the mobile station to estimate a predictive position and a predictive velocity of the mobile station after a predetermined period, and corresponding the state equation set to a graphic interface to calculate the predictive position and the predictive velocity.

The present invention further discloses an electronic device in a wireless communication system for performing the method in the above to determine a position of a mobile station of the wireless communication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a system model of the prior art according to TOA-based position estimation and tracking.

FIG. 2, FIG. 3 and FIG. 4 are schematic diagrams of factor graphs.

FIG. 5 is a schematic diagram for comparing computation results of the factor graph of FIG. 4 and practical computation results.

FIG. 6 is a schematic diagram of a process according to an embodiment of the present invention.

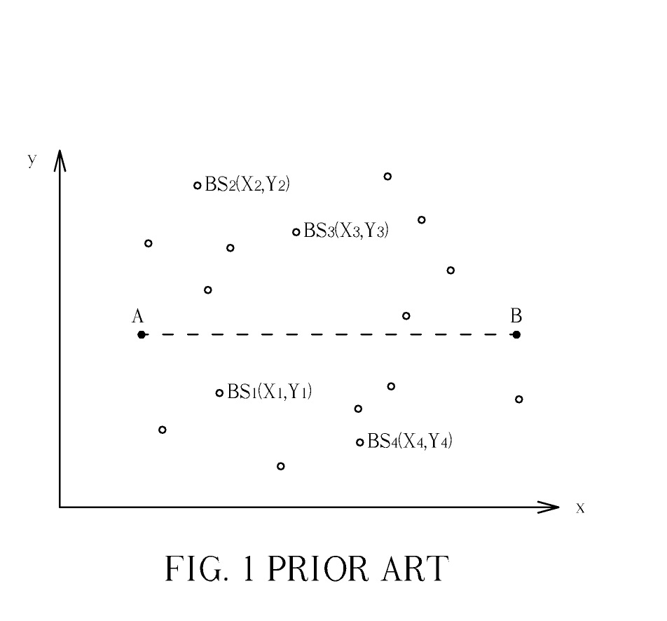

### DETAILED DESCRIPTION

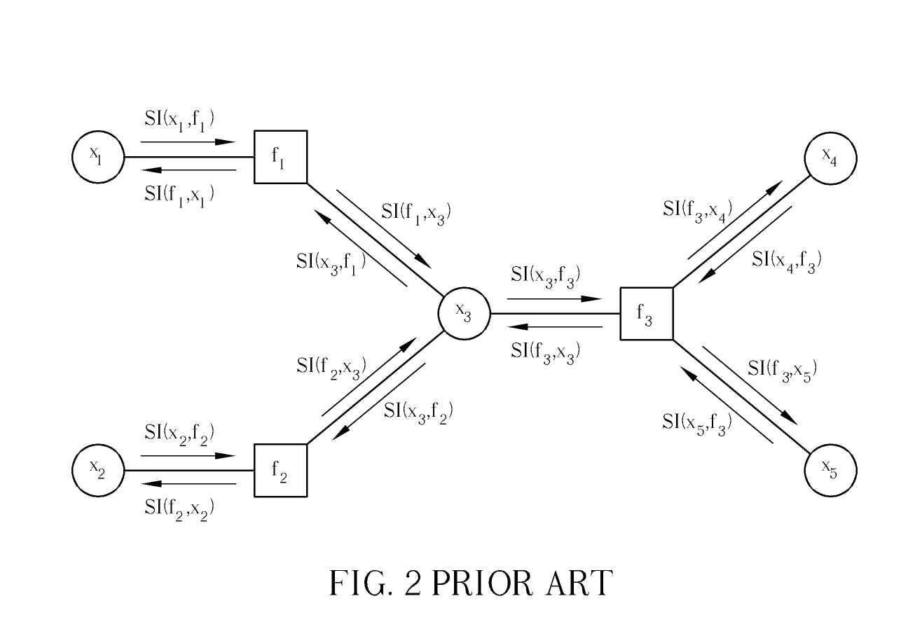

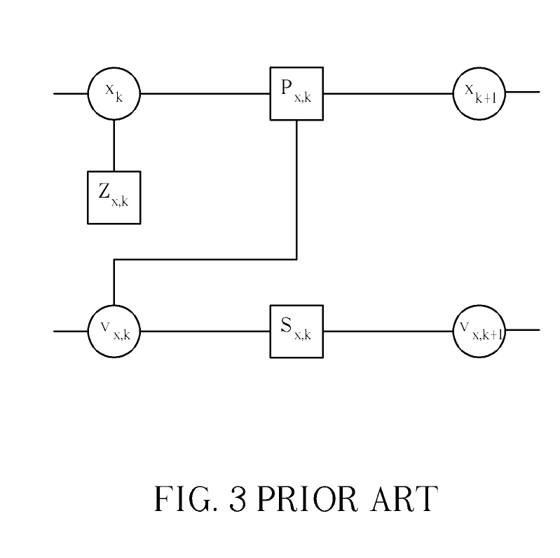

In order to simplify the computation of Eq. 1-Eq. 4, the present invention utilize a factor graph for overcoming disadvantages of the prior art. The factor graph employs sum-product algorithms to identically and effectively process codings in fields of communication, signal processing and artificial intelligence. Using advantages of the factor graph, the present invention solves EQ. 1-EQ. 4 with factor graphs, to simplify the computation of position estimation and tracking. Please refer to FIG. 2, which is a schematic diagram of a factor(graph, utilized for solving an equation:

ƒ(x₁,x₂,x₃,x₄,x₅)=ƒ₁(x₁,x₃)·ƒ₂(x₂,x₃)·ƒ₃(x₃,x₄,x₅) (Eq. 5)

In Eq. 5, the function ƒ is the product of the functions ƒ₁, ƒ₂ and ƒ₃. Meanwhile, the function ƒ₁ is merely related to x₁ and x₃, the function f₂ is merely related to x₂ and x₃, and the function ƒ₃ is merely related to x₃, x₄ and x₅. The main concept of the factor graph is graphically processing the relations between the variables and the functions. For example, in FIG. 2, the functions ƒ₁, ƒ₂, ƒ₃ are denoted by squares, named as constraint nodes or agent nodes, and the variables x₁˜x₅ are denoted by circles, named as variable nodes. Links between the constraint nodes and the variable nodes are determined according to the relations between the functions and the variables. For example, the function ƒ₁ is merely related to xᵢ and x₃, such that a constraint node corresponding to the function ƒ₁ is linked to variable nodes corresponding to xᵢ and x₃. By the same logic, the factor graph of FIG. 2 can be obtained. In addition, data transmitted between the constraint nodes and the variable nodes is referred as soft information (SI), which is only related to adjacent constraint nodes and variable nodes, and can be expressed as a combination of related SIs. For example, an SI SI(x₃,ƒ₃) transmitted from the variable node x₃ to the constraint node ƒ₃ can be expressed as:

SI(x₃,ƒ₃)=SI(ƒ₁,x₃)·SI(ƒ₂,x₃).

Analogically, the result of ƒ(x₁,x₂,x₃,x₄,x₅) can be obtained if the operation time is sufficient.

The factor graph is not only helpful to simplify the computation of Eq. 1-Eq. 4 but highly expandable as long as relations between extra nodes and original nodes are determined, because the relations between the functions and the variables are graphically expressed in the factor graph.

With the factor graph, the present invention simplifies the computation of Eq. 1-Eq. For example, in Eq. 3 and Eq. 4, equations related to the x coordinate of the mobile station are:

xₖ₊₁=xₖ+Δt·v_{x,k} (Eq. 6)

v_{x,k+1}=v_{x,k}+Δt·η_{v,x,k} (Eq. 7)

z_{x,k}=xₖ+w_{x,k} (Eq. 8)

Therefore, based on the operations of the factor graph, Eq. 6-Eq. 8 can be corresponded to FIG. 3. In FIG. 3, P_{x,k} denotes a constraint node related to variables xₖ₊₁, xₖ and v_{x,k}, and S_{x,k} denotes a constraint node related to variables v_{x,k} and v_{x,k+1}. By the same token, FIG. 4 is obtained by substituting equations related to the y coordinate of the mobile station in Eq. 3 and Eq. 4 into FIG. 3, and substituting Eq. 1 and Eq. 2 into FIG. 3. In FIG. 4, a range surrounded by dotted lines is corresponding to results of Eq. 1 and Eq. 2, and the reset is corresponding to results of Eq. 3 and Eq. 4. The main concept of the present invention is to simplify the computation of position estimation and tracking by the factor graph; thus, definitions of symbols and notations representing the nodes in FIG. 4 are not further narrated herein.

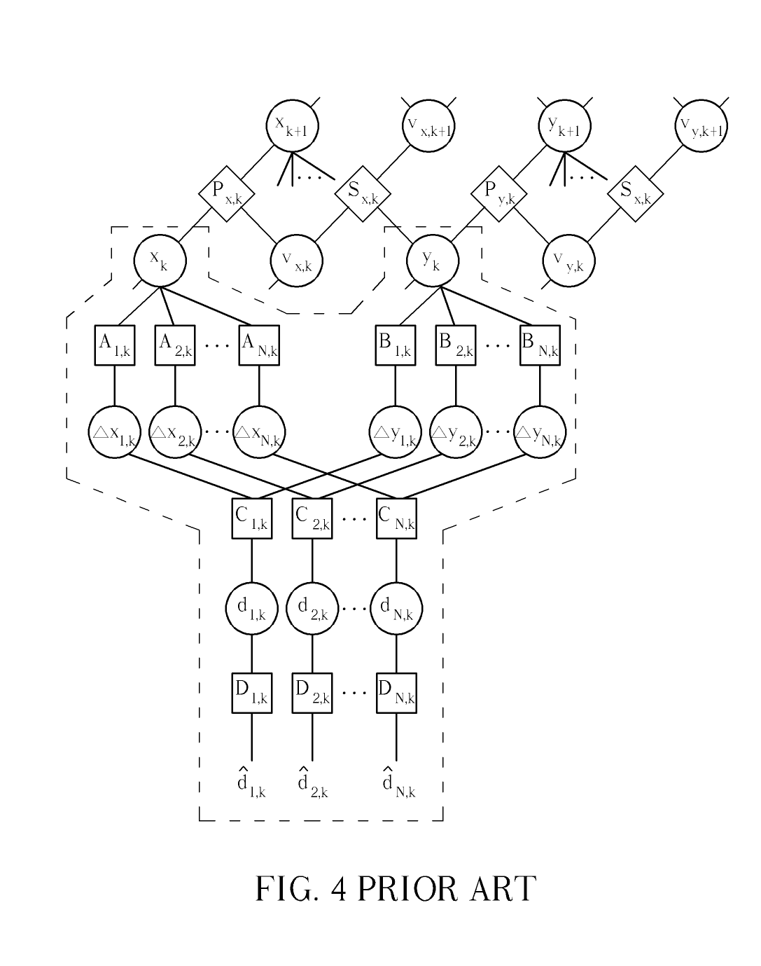

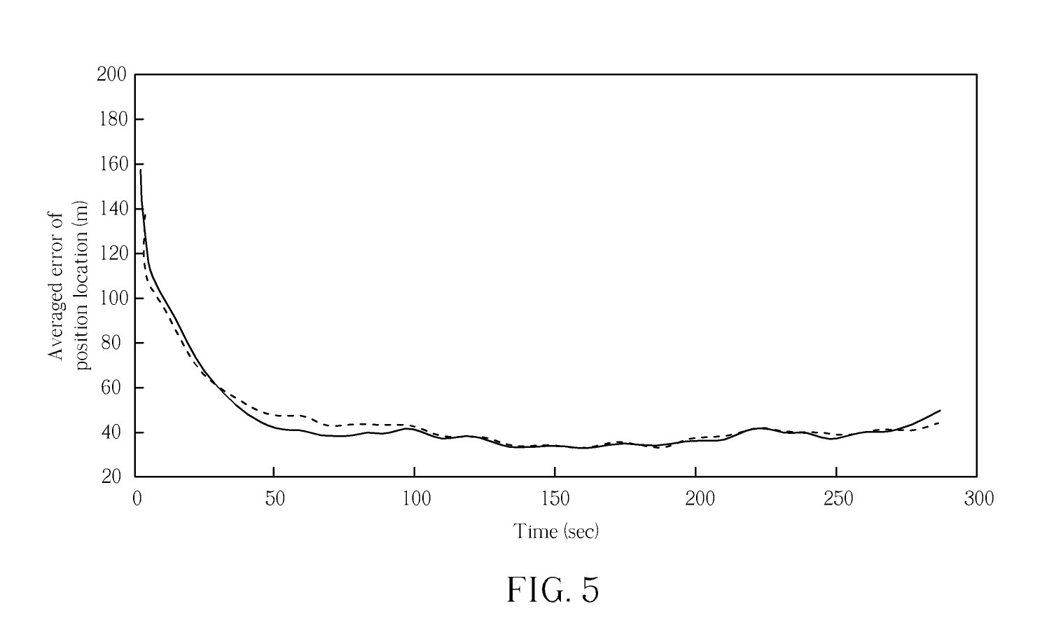

In short, the present invention uses the factor graph for simplifying the computation of position estimation and tracking. Note that, other graphic interfaces, such as a circle graph, can also be applied for the present invention. Besides, the factor graph cannot get results exactly equal to the results by numerical computation, but the difference thereof can be decreased as the trials increase. For example, in FIG. 5, a dotted line represents the results of the factor graph of FIG. 4, and a solid line represents the computation results of Eq. 1-Eq. 4. As time goes by (with more trials), the dotted line is getting closer to the solid line.

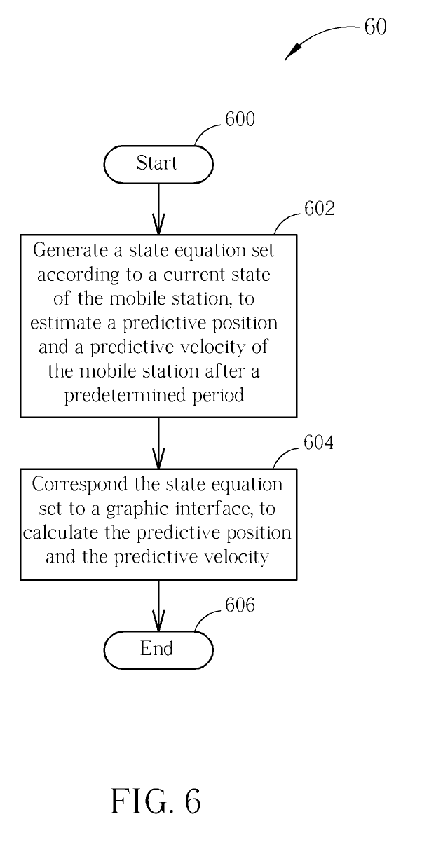

Operations of the factor graph or similar graphic interfaces can be summarized into a process 60, as illustrated in FIG. 6. The process 60 is utilized for determining a position of a mobile station in a wireless communication system, and includes:

Step 600: Start.

Step 602: Generate a state equation set according to a current state of the mobile station, to estimate a predictive position and a predictive velocity of the mobile station after a predetermined period.

Step 604: Correspond the state equation set to a graphic interface, to calculate the predictive position and the predictive velocity.

Step 606: End.

Note that, the factor graph is utilized for simplifying the computation of position estimation and tracking in the present invention, and the definitions of the mobile station and the base station should be well defined in hardware implementation according to different requirements. For example, in a global positioning system (GPS), the base station represents a positioning satellite, and the mobile stations represent navigation devices, receiving antennas, or the likes; thus, the process 60 is performed by the mobile stations. In a wireless local area network (WLAN), the base station represents an access point, and the mobile stations represent wireless network cards or related network devices; thus, the process 60 is performed by the access point. Therefore, when implementing the present invention, those skilled in the art can make modifications and variations based on practical requirements.

To sum up, the present invention uses the factor graph or other similar graphic interfaces to taking over complex numerical computation of position estimation and tracking. Since the factor graph has high efficiency and remarkable expandability, the present invention can effectively simplify the computation of position estimation and tracking, to overcome disadvantages of the prior art.

Those skilled in the art will readily observe that numerous modifications and alterations of the device and method may be made while retaining the teachings of the invention.

What is claimed is:

1. A method for determining a position of a mobile station in a wireless communication system comprising:
generating a state equation set according to a current state of the mobile station, to estimate a predictive position and a predictive velocity of the mobile station after a predetermined period; and
corresponding the state equation set to a graphic interface, to calculate the predictive position and the predictive velocity.

2. The method of claim 1, wherein the current state comprises a current position, a current velocity and a noise condition of the mobile station.

3. The method of claim 1 further comprising setting a two-dimension coordinate system, to represent the current position, the predictive position, the current velocity and the predictive velocity.

4. The method of claim 3, wherein the state equation set is represented by a matrix equation, written as:
$$[ \begin{matrix}{x}_{k + 1} \\ {y}_{k + 1} \\ {v}_{x , k + 1} \\ {v}_{y , k + 1}\end{matrix} ] = [ \begin{matrix}1 & 0 & Δ t & 0 \\ 0 & 1 & 0 & Δ t \\ 0 & 0 & 1 & 0 \\ 0 & 0 & 0 & 1\end{matrix} ] \cdot [ \begin{matrix}{x}_{k} \\ {y}_{k} \\ {v}_{x {,}_{k}} \\ {v}_{y {,}_{k}}\end{matrix} ] + Δ t [ \begin{matrix}0 \\ 0 \\ {η}_{v , x , k} \\ {η}_{v , y , k}\end{matrix} ]$$
wherein (xₖ, yₖ) represents the current position in the two-dimension coordinate system, (xₖ₊₁, yₖ₊₁) represents the predictive position of the mobile station corresponding to the two-dimension coordinate system, (v_{x,k},v_{y,k}) represents the current velocity of the mobile station corresponding to two-dimension coordinate system, [0 0 η_{v,x,k} η_{v,y,k}]^{T} represents the noise condition, and Δt represents the predetermined period.

5. The method of claim 1 further comprising:
computing a plurality of distances between the mobile station and a plurality of base stations of the wireless communication system; and
updating the graphic interface according to the plurality of distances, to compute the predictive position and the predictive velocity.

6. The method of claim 1, wherein the graphic interface is a factor graph.

7. The method of claim 1, wherein the graphic interface is a circle graph.

8. An electronic device in a wireless communication system, for performing the method of claim 1, to determine a position of a mobile station of the wireless communication system.
